(19) United States
(12) Patent Application Publication
(10) Pub. No.: US 2012/0230487 A1
(43) Pub. Date: Sep. 13, 2012

(54) METHOD AND APPARATUS FOR PROGRESSIVE CALL FORWARDING

(76) Inventors: Yiu Kau Leung, Morganville, NJ (US); Yiu Man Leung, Somerset, NJ (US)

(21) Appl. No.: 13/044,509

(22) Filed: Mar. 9, 2011

(51) Int. Cl. H04M 3/42

(52) U.S. Cl. 379/211.02

(57) ABSTRACT

The present invention describes a method and apparatus for providing an advanced call forwarding feature for telephone service subscribers. More specifically, the present invention provides a method and apparatus to forward a phone call to multiple phone numbers in a progressive manner. With this invention, when a phone number is called, the call is forwarded to a list of phone numbers in the following manner: a) call to the first phone number in the forwarding list, b) wait for a pre-provisioned period, if not answered, c) call to the second phone number from the list while the first phone is still ringing, if not answered by either phones, e) call yet another phone number from the forwarding list in the same manner until the end of the list while keeping all phones ringing simultaneously f) stop ringing of all other phone stations when one of the phone stations in the call list is picked up.

### TECHNICAL FIELD

This invention relates to a method and apparatus to provide an advanced call forwarding feature for telephone service subscribers. More specifically, the present invention provides a method and apparatus to forward a phone call to multiple phone numbers in a progressive manner. With this invention, when a phone number is called, the call is forwarded to a list of phone numbers in the following manner: a) call to the first phone number in the forwarding list, b) wait for a pre-provisioned period, if not answered, c) call to the second phone number from the list while the first phone is still ringing, if not answered by either phones, e) call yet another phone number from the forwarding list in the same manner until the end of the list while keeping all phones ringing simultaneously f) stop ringing of all other phone stations when one of the phone stations in the call list is picked up.

### BACKGROUND

The invention generally relates to progressive call forwarding and, more particularly, to a method to simultaneously forward the phone call to multiple phones in a progressive manner.

Call forwarding services for telephone subscribers are well known in the telephone industry. Various variations of current call forwarding services allow a subscriber to forward the incoming call to one or multiple pre-provisioned phone numbers.

The first variation of call forwarding allows a subscriber to forward a call to a different number. When the subscriber's phone number is called, the call is forwarded to the forwarding number automatically. The phone with the subscriber's phone number will not ring. The call can only be answered at the forwarded phone. This is the most common type of call forwarding service offered by phone companies.

The second variation of call forwarding allows a subscriber to provision multiple phones associated with the subscriber's phone number. When the subscriber's phone number is called, all the phones including the subscriber's phone will ring simultaneously. The call can be answered at any one of the phones. Google Voice is an example of such service.

However none of the present call forwarding variations allows adding a phone number to the forwarding call tree in a progressive manner as described in the present invention.

The Call Processing Language (CPL), a commonly used language to describe and control Internet telephony services, also includes a model of call forwarding service. However, the language does not contain any construct to describe the progressive call forwarding service in this invention.

Another telephony call control language, the Call Control eXtensible Markup Language (CCXML), provides a richer set of control constructs. However, without proper extension of defining new events beyond the standard events, the progressive call forwarding service in this invention cannot be expressed with the language.

In a technical customer support organization, there maybe a hierarchical organizations providing different levels of supports. For example, the first level of support organization provides answers to general technical questions from customers, while the second level of support organization provides more in depth answers. Yet another level of support of support provides customized solutions to individual customers which might involve product updates that are not available to general customers. Each level of organization also has a supervisor who normally will not answer the calls unless no one in the organization is available.

The well known call forwarding service can forward an unanswered call to one or multiple numbers simultaneously. The progress call forwarding service of this invention provides a better way to forward the call to different levels of support personnel in a progressive manner, thus improving the customer satisfaction. For example, if the call is not unanswered at the first level of support, after a time delay, the call is forwarded to the supervisor of the first level support, without disconnecting the call to the first level support. If the call is still not answered, according to the invention, the call is forwarded to the second level support, the supervisor of the second level, the third level support, and so forth. According to the invention, the call can be answered by anyone in the call chain at any time while the call is in progress.

The service is also useful for individual that has multiple residence or offices. In such case, the user can set the preference of order to answer the call in different locations.

### SUMMARY OF THE INVENTION

A method for providing progressive call forwarding feature from a phone station associated with a subscriber to a phone service provider is provided. In one embodiment, the method includes: a) connect to the first phone number in the forwarding list, b) wait for a pre-provisioned period, if not answered, c) connect the call to the second phone number from the list while the first phone is still ringing, if not answered by either phones, e) connect yet another phone number from the forwarding list in the same manner until the end of the list while keeping all phones ringing simultaneously g) stop ringing of all other phone stations when one of the phone stations in the call list is picked up.

In another embodiment, method of provisioning forwarding call chain list associated with a phone station is provided.

In one aspect of the invention, a method of adding/modifying a progressive call forwarding feature to a service plan for a telephone station is provided.

The method includes: a) receiving a request to add or modify a progressive call feature to the service profile from a user, wherein the request is initiated by the user via any phone station, or from a web page provided by the service provider, b) retrieving the user's service profile from a subscriber database, c) providing a list of phone numbers that the user stored in the service profile before that the user can choose to forward the call to, d) providing the user a choice to change the order of call forwarding phone numbers, e) providing the user a choice to change the delays between each call forwarding stage, the delays can optionally be zero, and f) storing the modified service profile in the subscriber database.

In another aspect of the invention, a method for forwarding a call in a progressive manner to multiple number numbers is provided.

The method includes: a) receiving an incoming call at the user's phone station, b) retrieving the user's service profile, c) if a progressive call forwarding feature is in effect, retrieving the forwarding numbers in the chain and the delay between each call forwarding stage, d) after the delay expired and the call is not answer, setting up a new call to the next number in the call forwarding chain, e) repeating step d) until the end of the call forwarding chain, f) establishing the call when any one of the called numbers answers the call, g) terminating the call chain after either one party hangs up the phone, or the call remains unanswered for a predefined period.

Benefits and advantages of the invention will become apparent to those of ordinary skill in the art upon reading and understanding the description of the invention provided herein.

### BRIEF DESCRIPTION OF THE DRAWINGS

FIG. 1 is a block diagram of an embodiment of a telecommunication system incorporating at least one aspect of the invention.

FIG. 2 is a block diagram of an embodiment of a process allowing a user to provision a progressive call feature in a subscriber profile.

FIG. 3 is a figure of components of a call processing system according to the present invention.

FIG. 4 is a call flow diagram of an embodiment of a method for forwarding a call to multiple phone numbers and a method of terminating the call.

### DETAILED DESCRIPTION OF THE INVENTION

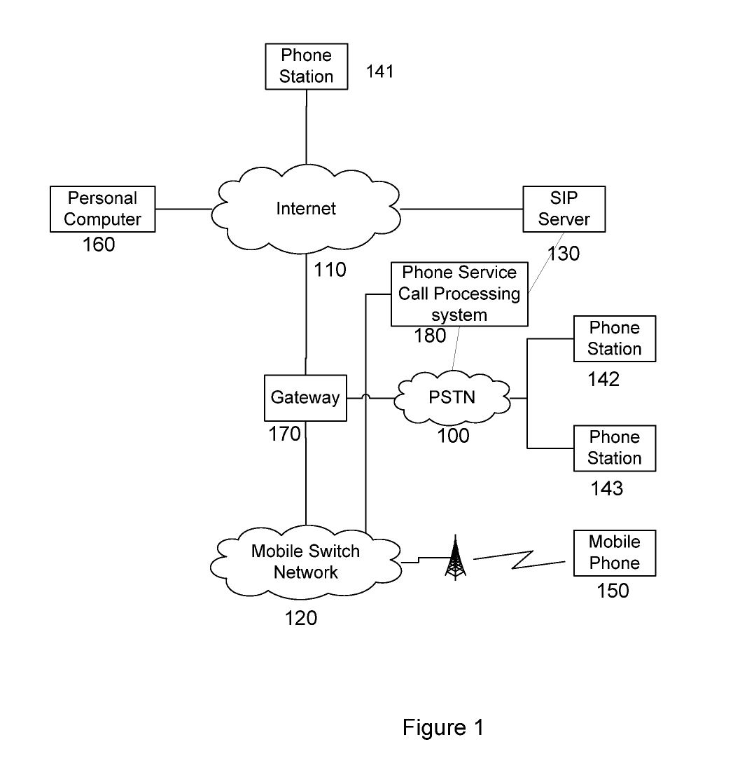

With reference to FIG. 1, a telephone telecommunication system incorporating at least one aspect of the invention includes a public switched telephone network (PSTN) 100, the public Internet 110, a VoIP network with a SIP server 130 and VOIP gateway 170, a wireless network 120, and a phone service call processing system 180. The phone service call processing system 180 provides the progressive call forwarding feature as described in the present invention. The call processing system 180 can accept calls from a public switched telephone network 100, a mobile switched network 120, or a VoIP network 130 and forward calls to any devices connected to one or multiple of the above networks. While this is a typical arrangement of the networks and devices, this invention can be applied to other network arrangement, for example, the public Internet can be replaced by a managed private IP network as typically used in the core VOIP network. The terminal devices can be a traditional landline telephone station 141, 142, 143, a mobile phone 150, a personal computer 160, or any network enabled device.

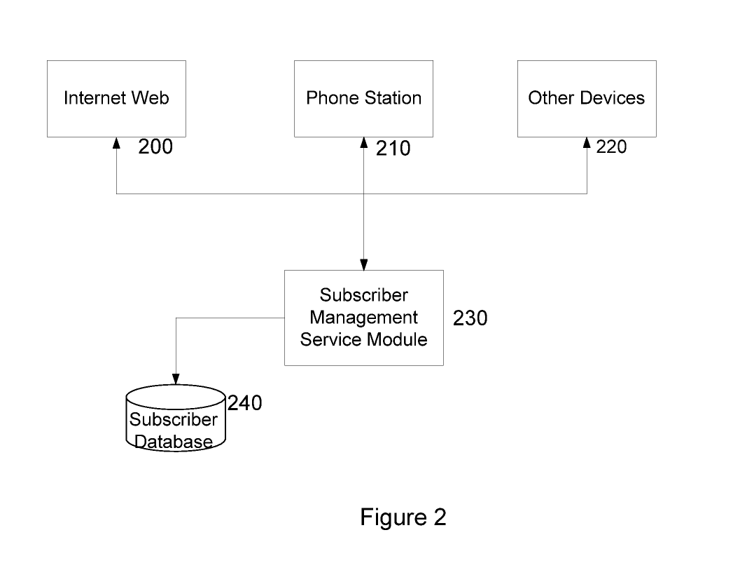

With reference to FIG. 2, a Subscriber Management system incorporating at least one aspect of the invention includes a Subscriber Management Service Module 230, a Subscriber Database 240, user's own phone station 210, other terminal devices 220, and a web application 200.

A telephone station in this invention refers to but not limited to the traditional landline telephone station, a mobile telephone, a PC with appropriate software, or any portable device with capability connecting to any part of the network as shown in FIG. 1, or any communication network. Each device has a unique identifier in the network, such as a telephone number, a user name provided by any service provider in the communication network, a Universal Resource Identifier (URI), or unique device identification such as Media Access Control (MAC) address assigned to the device. Any unique identifier can be used to identify the device as the destination of the call.

Before a user can use the progressive call forwarding feature according to the invention, the feature must be provisioned in the subscriber management system in the communication network. The subscriber management system includes a Subscriber Management Service Module 230 which provides direct interfaces to any devices in the network 210, and a web-based front-end 200 which could be accessed from anywhere in the network with any device not limited to a personal computer, PDA, or smart-phone with Internet access.

In one embodiment of the invention, the user accesses the subscriber management system from his/her own phone device 210, the system can be accessed by pressing a special hardware key or dialing a special number. Once the system is connected, the system retrieves the user's calling profile from the subscriber database using the device's unique identifier.

A user calling profile comprises the unique identifier of the user, a list of device identifiers, a list of options associated with each device, order of the devices in the progressive calling. The list of options associated with each device comprises a list of time-of-day ranges, delay period before calling the next device in the list. The delay can optionally be zero.

The user is then given the choice to turn on or turn off the progressive call forwarding feature. The user is further prompted for the forwarding numbers, the delay between each call. A default delay between the call can be set if the user choose not to input his own choice. After user input all the phone numbers and delays, the user can choose to save the call profile to the database. The input method including using the keypad or voice recognition technology does not have different effect of the invention.

In another embodiment of the invention, the user accesses the subscriber management system from any device 220 connecting to the network. The unique identifier of the device that accepts the call forwarding feature is input to the system. The system retrieves the user's calling profile from the subscriber database using the device's unique identifier input by the user.

The user is then given the choice to turn on or turn off the progressive call forwarding feature. The user is further prompted for the forwarding numbers, the delay between each call. A default delay between the call can be set if the user choose not to input his own choice. After user input all the phone numbers and delays, the user can choose to save the call profile to the database. The input method including using the keypad or voice recognition technology does not have different effect of the invention.

In yet another embodiment of the invention, the user accesses the subscriber management system from any device connected to the Internet. A web page is presented to the user by a Web application 200. Access to the system is protected by requiring the user to input the user identifier and password before accessing the subscriber management system. The user identifier can be the managed device unique identifier or any identifier provided by the service provider to the user.

The web page includes the input fields for the device identifier to be managed, a choice to turn on and off of the progress call forwarding feature, a list of destination device identifiers in sequential order, and the delays between the progressive call to the next device in the list. The web page also includes a button to save the updated data. The web page can be presented to the user in one or multiple pages.

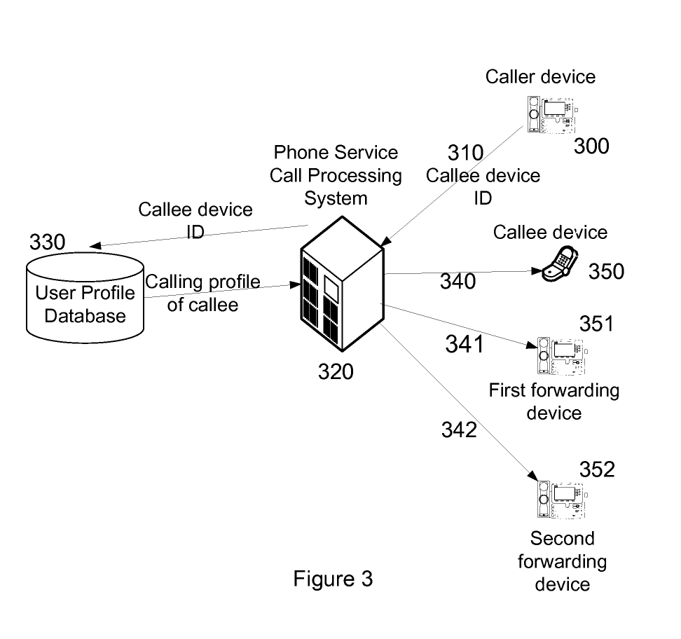

With reference to FIG. 3, a call processing system 320 according to the present invention is connected to the user profile database 330. The terminal devices of caller and callee, and the forwarding devices of the callee are connected to the call processing system through any network including but not limited to a public switched telephone network, a VoIP network, or a mobile switching network. When the caller makes a call to the callee, the device identifier of the callee is dialed at the caller's device 310. The callee's device identifier is used as a key to the user profile database 330 to look up the calling profile of the callee. As described in preceding embodiments, the calling profile comprises a list of device identifiers that can reach the callee, a list of options associated with each device, order of the devices in the progressive calling. The list of options associated with each device comprises a list of time-of-day ranges, delay period before calling the next device in the list. The call processing system then first attempts to call the callee device 350 using any calling processing protocol 340. If the callee does not answer the call after a period of time as defined in the calling profile, the call processing system then attempts to call the first forwarding device 351 in the list 341 based on the time-of-day constraints while the callee's device is still ring. If the call is not answered after a period of time as defined in the calling profile, and there is still another forwarding device in the list satisfying the time-of day constraint, the call processing system then adds the second forwarding device 352 to the call tree 342 while letting the callee's device and the first forwarding device keep ringing. The call processing system can add any number of forwarding devices to the call tree as defined in the calling profile. If the call is answered at any one of the device, the call processing system stop ring all other devices. The call can be terminated later either by the caller or the callee.

Setting the delay period to zero has a special application as described in the following example. A company support center has a toll free number for several levels of supports. Each level of support has multiple phone stations each having unique identifiers. It is desirable when a customer call the toll free number; all phone stations at level one ring simultaneously. If no one answers the call at any phone station at level one, the call is forwarded to the second level while keeping all phones at level one ringing. Similarly, it is desirable to ring all phone stations in the call tree simultaneously. If no one answers the call at any phone stations at either level one or level two, the call is forwarded to the third level, and so on. Such forwarding pattern can be achieved by provisioning the delay period of all phones at level one with a zero value. The call processing system will then add all phone stations at level one to the call tree without any delay. Similarly, the delay period of all phone stations at level two can be provisioned to the same value and the delay period of all phone stations at level three can be provisioned to another value, and so on. With the present invention, all the phone stations at level two will then be added to the call tree and ring simultaneously after a set delay. Similarly, all the phones at level three will be added to the call tree and ring simultaneously after another set delay.

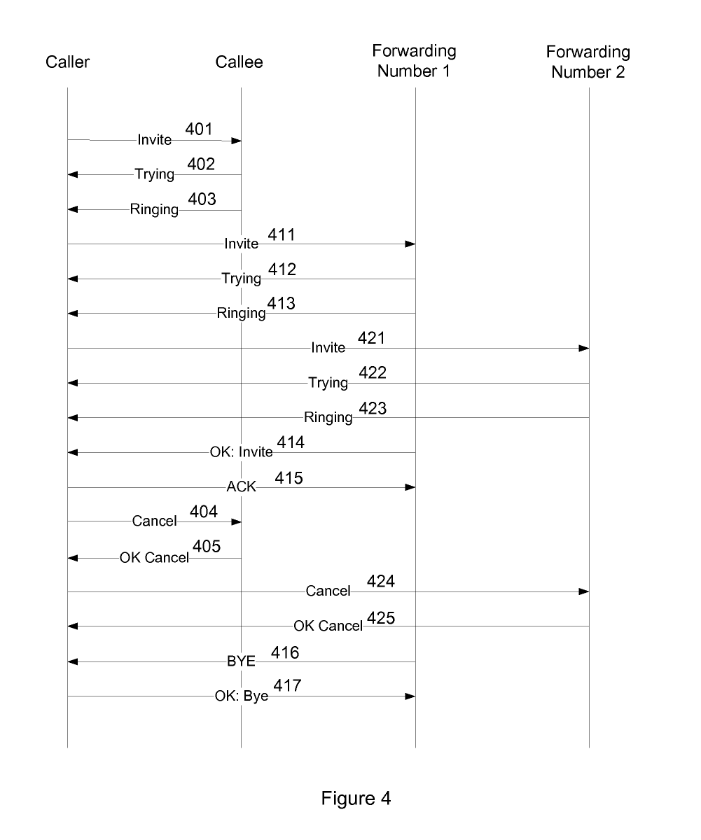

With reference to FIG. 4, a message flow diagram incorporation at least one aspect of the invention includes the messages flow between the caller, the callee, and multiple forwarding numbers using the SIP protocol. While SIP is a common protocol in voice over IP application, the invention can be applied to other call processing protocol with the similar effect.

When the caller makes a call to the callee, the system looks up the subscriber database for the calling profile of the callee. The calling profile of the callee comprises a list of device identifiers that can reach the callee, a list of options associated with each device, order of the devices in the progressive calling. The list of options associated with each device comprises a list of time-of-day ranges, delay period before calling the next device in the list. The call processing system then sends an SIP invite message 401 to the device of the callee. The device responds with a SIP trying message 402. If the device is not busy, the device responds with a SIP trying message followed by a SIP ring message when the device rings 403.

If the callee does not answer for a period as defined in the calling profile, the call processing system then attempts to forward the call to the first forwarding device in the list using similar procedures. A SIP invite message 411 is sent to the first forwarding device. The first forwarding device responds with a SIP trying message 412 and a SIP ring message 413. Note that the callee's device is still ringing as the call is not cancelled yet.

If the callee does not answer callee device and the first forwarding device for a period as defined in the calling profile, and there is a second forwarding device in the list, the call processing system then attempts to forwarding the call to the second forwarding device using the similar procedures. A SIP invite message 421 is sent to the second forwarding device. The second forwarding device responds with a SIP trying message 422 and a SIP ring message 423. Note that the callee's device and the first forwarding device are still ringing as the calls are not cancelled yet.

Now the callee answers the call at the first forwarding device. The device sends a SIP OK: Invite message 414 and the caller and the first forwarding device are connected. The call processing system sends a SIP cancel message 404, 424 to both the callee's device and the second forwarding device to stop the ringing on the devices. Both device responds with a SIP OK: cancel message 405, 425 to terminate the call.

Finally the callee hangs up at the first forwarding device. The device sends a SIP bye message 416 to the caller's device to terminate the call. The caller's device optionally responds with a SIP OK message 417.

In another embodiment of the invention, the call processing system can skip the devices that are busy. For example if the callee's first forwarding device is busy, the second forwarding device is added to the call tree as described before, skipping the first forwarding device.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

What is claimed is:

1. A method of forwarding a phone call in a progressive manner, comprising:
a calling profile associate with the callee;
and steps of:
accepting a call for the callee;
looking up the calling profile of the callee using the unique identifier of the callee;
making a call to the device associated with the callee's unique identifier;
adding at least one terminal device in the forwarding list from the calling profile of the callee to the call tree in a progressive manner;
terminating the call.

2. The method of claim 1, wherein the calling profile comprising the unique identifier of the user, a list of terminal device identifiers, a list of options associated with each device, order of the devices in the progressive calling.

3. The method of claim 2, wherein the list of options associated with each device comprises a list of time-of-day ranges, delay period before calling the next device in the list.

4. The method of claim 1, wherein the call to the callee can be accepted from one of a public switched telephone network, VoIP network, a mobile switched network, and any other communication network.

5. The method of claim 1, wherein the call can be forwarded to one of a public switched telephone network, a VoIP network, a mobile switched network, and any other communication network.

6. The method of claim 1, wherein at least one terminal device in the forwarding list is added to the call tree based on the order as provisioned in the calling profile of the callee.

7. The method of claim 6, wherein at least one terminal device in the forwarding list is added to the call tree based on the time-of-day constraints as provisioned in the option list associated with the devices.

8. The method of claim 6, wherein at least one terminal device in the forwarding list is added to the call tree based on the delay as provisioned in the options associated with the device.

9. The method of claim 1, wherein all terminal devices added to the call tree ring simultaneously.

10. The method of claim 1, wherein the call can be answered by any one of the terminal devices in the call tree.

11. The method of claim 1, wherein all other terminal devices in the call tree stop ringing once the call is answered by one of the terminal devices in the call tree.

12. A system of forwarding a phone call in a progressive manner, comprising:
a database of calling profiles;
a subscriber management system;
a phone call processing system capable of:
accepting a call for the callee;
looking up the calling profile of the callee using the unique identifier of the callee;
making a call to the device associated with the callee's unique identifier;
adding at least one terminal device in the forwarding list from the calling profile of the callee to the call tree in a progressive manner;
terminating the call.

13. The system of claim 12, wherein the calling profile comprising the unique identifier of the user, a list of terminal device identifiers, a list of options associated with each device, order of the devices in the progressive calling.

14. The system of claim 13, wherein the list of options associated with each device comprises a list of time-of-day ranges, delay period before calling the next device in the list.

15. The system of claim 12, wherein the subscriber management system accepts connection from any terminal devices.

16. The system of claim 12, wherein the subscriber management system includes a web application which can be accessed by any Internet enabled devices.

17. The system of claim 12, wherein the subscriber management system provides all user interfaces to maintain the calling profile of a user, allowing a user to enable/disable the progressive call feature, add/modify/delete a list of terminal devices, add/modify/delete the options associated with each device in the list.

18. The system of claim 12, wherein the phone call processing system can access the calling profile of a user using a unique identifier of the user.

19. The system of claim 12, wherein the phone call processing system can accept calls from one of a public switched telephone network, VoIP network, a mobile switched network, and any other communication network.

20. The system of claim 12, wherein the phone call processing system can forward calls to one of a public switched telephone network, a VoIP network, a mobile switched network, and any other communication network.

21. The system of claim 12, wherein the phone call processing system can add at least one terminal device in the forwarding list to the call tree based on the order as provisioned in the calling profile of the callee.

22. The system of claim 21, wherein the phone call processing system can add at least one terminal to the call tree based on the time-of-day constraints as provisioned in the option list associated with the devices.

23. The system of claim 21, wherein the phone call processing system can add at least one terminal to the call tree based on the delay as provisioned in the options associated with the device.

24. The system of claim 12, wherein phone call processing system rings all terminal devices in the call tree ring simultaneously.

25. The system of claim 12, wherein the call can be answered by any one of the terminal devices in the call tree.

26. The method of claim 1, wherein all other terminal devices in the call tree stop ringing once the call is answered by one of the terminal devices in the call tree.
